(19) United States
(12) Patent Application Publication
(10) Pub. No.: US 2026/0099519 A1
(43) Pub. Date: Apr. 9, 2026

(54) SYSTEMS AND METHODS FOR IMPROVED DATA PROCESSING OF COMMUNICATIONS ACROSS COMPUTER NETWORKS USING TRIFURCATED PROMPTS

(71) Applicant: Capital One Services, LLC, McLean, VA (US)

(72) Inventors: Chi ZHANG, Cambridge, MA (US); Vivek DATLA, Ashland, MA (US); Aditya SHRIVASTAVA, New York, NY (US); Alfy SAMUEL, White Plains, NY (US); Anoop KUMAR, Fountain Valley, CA (US); Daben LIU, Belmont, MA (US)

(73) Assignee: Capital One Services, LLC, McLean, VA (US)

(21) Appl. No.: 19/069,204

(22) Filed: Mar. 3, 2025

Related U.S. Application Data
(60) Provisional application No. 63/703,436, filed on Oct. 4, 2024.

(51) Int. Cl. G06F 16/3329; G06F 40/247; G06F 40/284; G06N 5/043

(52) U.S. Cl. CPC G06F 16/33295; G06F 40/247; G06F 40/284; G06N 5/043

(57) ABSTRACT

Systems and methods for improved data processing of communications across computer networks using trifurcated prompts during communication exchanges are described. For example, the system may receive a first inbound communication, wherein the first inbound communication system may determine a first context for the first inbound communication based on the first text string. The system may process the first context in a perturbation model to determining a first perturbed context, wherein the perturbation model determines the first perturbed context by determining a first alternative token for a first token in the first context. The system may determine a first prompt for a first large language model based on the first perturbed context.

### CROSS-REFERNECE TO RELATED APPLICATION(S)

This application claims the benefit of priority of U.S. Provisional Ser. No. 63/703,436, filed Oct. 4, 2024. The content of the foregoing application is incorporated herein in its entirety by reference.

### BACKGROUND

The advent of large language models (LLMs) has improved many natural language processing (NLP) tasks, with one of the most significant applications being Retrieval-Augmented Generation (RAG). RAG has been successfully applied across a wide range of industries due to its ability to enhance language generation with the integration of external knowledge sources. By combining information retrieval with powerful generative capabilities, RAG enables models to generate more accurate, contextually relevant responses to complex queries.

### SUMMARY

However, a key challenge in deploying RAG systems is the potential for the underlying language model to generate answers from its memory rather than relying on the specific context provided. This behavior is especially dangerous as the current guardrails i.e., current evaluation methodologies primarily assess the correctness of the answer without scrutinizing the process by which the model arrived at that answer. Thus, even when a response is factually correct, the model may not have utilized the context properly, making it difficult to detect reliability issues.

This problem becomes more pronounced with LLMs, which are trained on vast datasets and often produce correct answers even when context is absent or incorrect. The sheer volume of training data enables these models to recall information from memory, creating the illusion of correctness without context alignment. As these models are increasingly used in real-world applications, where the inputs are often unseen or unfamiliar, the risk of incorrect or contextually irrelevant answers grows. This highlights the critical need to distinguish between genuinely context driven responses and those generated from the model's pre-existing knowledge.

Systems and methods are described herein account for these technical problems through the use of a trifurcated prompt for a model. For example, the trifurcated prompt may include an instruction, context, and question to the model. By trifurcating the prompt, the system may generate a perturbed context to replace the existing context while still maintaining a prompt that may be processable. Moreover, through the use of the perturbed context, the system may evaluate the model's confusion when having a quantified perturbation and model the variation of confusion, as the perturbations get bigger or the perturbations specific to the sensitives of the LLM to infer the closeness of the generated output to a ground truth, specifically targeting the most confusing tokens within that context. Ultimately, by evaluating the model's confusion, the system may distinguish between genuinely context driven responses and those generated from the model's pre-existing knowledge.

In some aspects, systems and methods for improved data processing of communications across computer networks using trifurcated prompts during communication exchanges are described. For example, the system may receive a first inbound communication, wherein the first inbound communication comprises a first text string. The system may determine a first context for the first inbound communication based on the first text string. The system may process the first context in a perturbation model to determining a first perturbed context, wherein the perturbation model determines the first perturbed context by determining a first alternative token for a first token in the first context. The system may determine a first prompt for a first large language model, wherein the first prompt comprises a first instruction, a first question, and the first perturbed context. The system may process the first prompt in the first large language model to generate a first outbound communication.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1A shows an illustrative diagram for a trifurcated prompt, in accordance with one or more embodiments.

FIG. 1B shows an illustrative diagram for a perturbed context, in accordance with one or more embodiments.

FIG. 2 shows an illustrative diagram for a perturbation model, in accordance with one or more embodiments.

FIG. 3 shows illustrative components for a system for improved data processing of communications across computer networks, in accordance with one or more embodiments.

FIG. 4 shows a flowchart of the steps involved in using trifurcated prompts during communication exchanges, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

In sensitive domains like finance and healthcare, it is crucial to assess the accuracy of outputs generated by retrieval-augmented generation (RAG) models. Existing methods, such as hallucination detection and entailment measurement, fail to capture the model's internal state during answer generation. The systems and methods introduce a novel approach to distinguish whether RAG-generated responses stem from the model's memory or the provided context and presents a method to quantify answer correctness by modeling the model's internal confusion. Extensive experiments across multiple large language models (LLMs) demonstrate that our approach effectively quantifies RAG robustness, allowing users to apply customizable metrics to predict the alignment with ground truth.

For example, the advent of large language models (LLMs) has improved many natural language processing (NLP) tasks, with one of the most significant applications being Retrieval-Augmented Generation (RAG). RAG has been successfully applied across a wide range of industries due to its ability to enhance language generation with the integration of external knowledge sources. By combining information retrieval with powerful generative capabilities, RAG enables models to generate more accurate, contextually relevant responses to complex queries. The use of Retrieval-Augmented Generation (RAG) systems in domain-constrained environments such as finance, healthcare, and legal applications presents significant risks. In these high-stakes domains, providing a wrong or inappropriate answer can lead to severe consequences, particularly when the response has legal or ethical implications. A key challenge in deploying RAG systems in such contexts is the potential for the underlying language model to generate answers from its memory rather than relying on the specific context provided. This behavior is especially dangerous, as the current guardrails i.e., current evaluation methodologies, primarily assess the correctness of the answer without scrutinizing the process by which the model arrived at that answer. Thus, even when a response is factually correct, the model may not have utilized the context properly, making it difficult to detect reliability issues.

This problem becomes more pronounced with larger language models (LLMs), which are trained on vast datasets and often produce correct answers even when context is absent or incorrect. The sheer volume of training data enables these models to recall information from memory, creating the illusion of correctness without context alignment. As these models are increasingly used in real-world applications, where the inputs are often unseen or unfamiliar, the risk of incorrect or contextually irrelevant answers grows. This highlights the critical need to distinguish between genuinely context driven responses and those generated from the model's pre-existing knowledge.

An illustrative example of this issue is the “third variable problem,” such as the statistical correlation that people who eat ice cream are more likely to drown. While the correlation may be true on a population level, the underlying cause is not ice cream consumption, but rather the fact that people are more likely to swim during the summer months when ice cream consumption is also higher. Similarly, large language models trained on extensive corpora, often perform well on test sets derived from these corpora. However, in real-world applications with novel inputs, the models are more likely to generate answers from memory rather than context, increasing the risk of unreliable outputs.

As test performance continues to excel, the gap between model performance on benchmark datasets and real-world data becomes more apparent, raising concerns about the reliability of these systems in critical, domain-specific tasks. Identifying and addressing these hidden risks is essential to ensure the safe and accurate deployment of RAG systems in sensitive industries.

At its core, RAG involves two key processes: retrieving pertinent information in response to a query and generating answers based on that retrieved content. The retrieval component ensures that the model has access to documents or passages most relevant to the input query, while the generation component synthesizes this information into coherent, informative responses.

To evaluate the performance of RAG systems, accuracy is typically measured at several levels of granularity. First, it is essential to assess whether the retrieval mechanism is successfully identifying documents or data relevant to the query. Second, the correctness of the generated answer is evaluated against a predefined ground truth. Finally, various aspects of the relationship between the generated response and the input query, such as coherence, relevance, and factual consistency, are measured to ensure the overall quality of the model's output.

The core component of generation component of a Retrieval-Augmented Generation (RAG) system is still a large language model (LLM), which generates answers based on the provided instructions, questions, and context. However, there are several scenarios where the LLM can fail and produce incorrect answers: 1) if instruction provided to the LLM is inaccurate; 2) if a wrong context is provided for a given question; and 3) if a LLM relies solely on its pre-training without utilizing the context.

While the RAG framework mitigates some of these limitations—such as outdated or incorrect information—by retrieving up-to-date data before generating answers, it still faces challenges in providing a reliable confidence or correctness estimation for the model's output. Specifically, the system may determine the impact on the generated output when the model becomes confused. For example, the system may determine if there are identifiable patterns of confusion when the model fails to provide the correct answer, does the LLM exhibit pre-learned behaviors where it ignores the input and instead generates responses from its memory, and/or are there particular input patterns that lead to confusion and increase the likelihood of errors in the generated output? Understanding confusion within an LLM during text generation is a critical metric, as it provides valuable insight into the model's internal state when predicting the next token. All LLMs generate tokens sequentially based on their vocabulary, which is defined by the model's tokenizer. It is important to note that multiple models within the same family often use the same tokenizer, but differ in terms of size, with variations in the number of parameters. Notably, the generation of the next token may pose different levels of difficulty, or “confusion,” across models of the same family (or class). Historically, the goal of perturbing text input is to test the model's ability to still generate accurate, coherent, and contextually relevant responses despite the changes. This technique is valuable for improving the robustness of LLMs, particularly when they are deployed in real-world applications where input data may be noisy, incomplete, or imperfect.

The system evaluates the model's confusion when having a quantified perturbation and model the variation of confusion as the perturbations get bigger or the perturbations specific to the sensitives of the LLM to infer the closeness of the generated output to the ground truth. A next token generation that is straightforward for a larger model with more parameters may be highly confusing for a smaller model. For example, the system explores the boundaries of this confusion by introducing perturbations to the input context, specifically targeting the most confusing tokens within that context. The system highlights that text generated by a large language model (LLM) often lies in regions of negative curvature within the model's log probability function, and determines if its perturbation behaves significantly differently from text generated from different model or human.

In some embodiments, the system may further introduce controlled noise across models of varying sizes within the same family and different model families (or classes) to assess how each model handles these perturbations, and to identify at what point confusion significantly impacts the answer generated by LLM.

Perturbation of text input to an LLM may refer to the intentional alteration or modification of the input data provided to a large language model (LLM) in order to evaluate its robustness, sensitivity, and generalization capabilities. These perturbations can be small but significant changes, such as: word substitutions (e.g., replacing specific words with synonyms, misspellings, or out-of-vocabulary terms); sentence restructuring (e.g., changing the order of words or sentences while maintaining the overall meaning); noise injection (e.g., introducing random errors, typos, or irrelevant data into the input); contextual modifications (e.g., removing or altering certain contextual clues to see how the model reacts to incomplete or ambiguous information).

Perturbations have been extensively used for studying the robustness of models by creating synthetic adversarial examples. Contextualized adversarial generation model may generate perturbation on the input text using various combinations of replacement, insertion, and deletion of the text. For example, the model may test the minimum or efficient edits to achieve a successful adversarial behavior of the LLMs. In some embodiments, the system may demonstrate that by exploiting entailment features, even when assuming the target model is a black box, it is possible to make classifiers change their predictions. Specifically, the method identifies key words in the target model and prioritizes replacing them with semantically similar and grammatically correct alternatives, causing models trained on BERT embeddings to alter their responses.

The system may use a perturbation algorithm that determines contextual perturbations using an LLM showed promising results for creating confusing contexts to the models. The system may further improve on this by identifying “where” to perturb, based on the model's inherent confusion. When using an LLM to generate text, the system may observe inflection points where the model exhibits low confidence and mask those tokens. The system may observe NLL changes as the model generates text, then perturb the text strategically by determining “when,” “where,” and “how” to modify it. This allows the system to evaluate the model's behavior during output generation. The model may help in identifying the truthfulness of the generated answers by finding patterns in the hidden layers when the model is generating the answer. The system may determine model variations of activation across hidden layers as a solution to handle hallucinations.

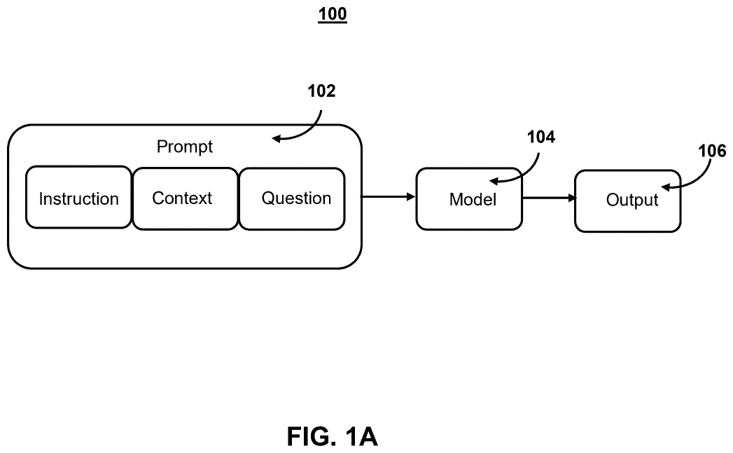

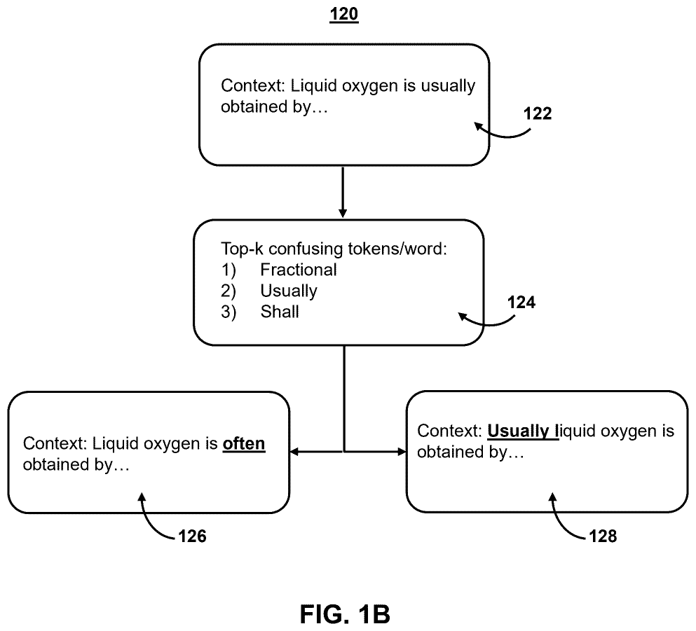

FIG. 1A shows an illustrative diagram for a trifurcated prompt, in accordance with one or more embodiments. For example, in some embodiments, the system may receive and/or generate prompts for display on a user interface. As referred to herein, a “user interface” may comprise a human-computer interaction and communication in a device, and may include display screens, keyboards, a mouse, and the appearance of a desktop. For example, a user interface may comprise a way a user interacts with an application or a website. As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same.

For example, FIG. 1A shows component 100. Component 100 includes prompt 102, which itself includes an instruction, context, and question component. Having built prompt 102 to comprises the instruction, context, and question components, prompt 102 is input into model 104 (which may be an LLM). Component 100 may then generate output 106 (which may be an answer provided to a user).

For instance, component 100 may generate a prompt, referred to as prompt 102, by first analyzing the task or input it has received. Based on this analysis, the component determines the instruction, which clearly defines the action the LLM should perform, such as “Summarize,” “Answer the question,” or “Generate a response.” Next, the context is constructed by incorporating relevant background information or data that provides the necessary details for the LLM to understand the scenario. This could include excerpts from a document, conversational history, or additional input data related to the task.

Once the instruction and context are established, the component formulates a question to direct the LLM's focus to specific details or clarify what is being requested. For example, the question might be “What is the main idea of the following text?” or “What is the current status of the project?” These three components—instruction, context, and question—are combined to create the complete prompt 102.

Prompt 102 is then input into Model 104, which processes the structured prompt using its trained parameters to generate a response. This response, referred to as output 106, is typically a textual answer or action-ready output aligned with the task defined in the prompt. Component 100 may further refine or format output 106 before providing it to the user, ensuring the response is accurate, relevant, and ready for consumption. By structuring the prompt in this manner, component 100 ensures that the LLM receives clear and actionable input, resulting in a coherent and effective output.

FIG. 1B shows an illustrative diagram for a perturbed context, in accordance with one or more embodiments. System 120 may comprise determine a perturbed context based on a determined context. For example, an input to the LLM within the RAG framework may be structured as a prompt comprising three components: the instruction, the context (e.g., context 122), and the question.

The system may apply controlled modifications to examine the impact of a perturbed context. For example, the system may manipulate the context along a plurality of dimensions (e.g., what is perturbed, where the perturbation occurs, how the perturbation is applied, etc.).

For example, as shown in FIG. 1B, system 120 may perturb the context based on the most confusing token (e.g., based on list 124), as identified by a perturbation model, which may be another LLM. This entropy-based perturbation may contrast with a random approach where the perturbation model used may belong to the same model family as the base LLM and can vary in size, either smaller or larger than the base model. For example, to ensure controlled modification of the input context based on the most confusing tokens, a process leverages a perturbation model, such as another LLM configured with specific characteristics (e.g., type, size, or hyperparameters). For a given input text consisting of N tokens, the process begins by calculating the negative log-likelihood (NLL) of generating each token using the perturbation model. This step identifies the tokens that the model finds most improbable or “confusing” based on its internal representations. The token with the lowest log-likelihood is flagged as the most confusing token because it is least consistent with the model's learned patterns. Once the most confusing token is identified, it is replaced with a masked token compatible with the perturbation model. The model then predicts and fills in the masked position, generating an alternative token that aligns with its understanding of the surrounding context. This modification introduces controlled variability into the input context while maintaining semantic and syntactic coherence. The process can proceed in one of two settings: iterative perturbation or single-shot perturbation. In the iterative perturbation setting, the process is repeated across Ksteps (where K is a predefined hyperparameter). In each step, the system recalculates the NLL for the updated input, identifies the next most confusing token, masks it, and uses the perturbation model to generate its replacement. This iterative approach allows for a stepwise and granular modification of the context.

In some embodiments, system 120 may apply the perturbations iteratively—degrading the context one token at a time—or in a single-shot approach, where multiple perturbations are introduced simultaneously. This allows for a controlled examination of how different perturbation strategies impact model behavior. For example, the single-shot perturbation setting identifies all K most confusing tokens in one analysis step. These tokens are simultaneously masked and filled by the perturbation model in a single operation. This approach is faster and efficient for scenarios where multiple perturbations are required without stepwise iteration. By dynamically adapting the input context in this controlled manner, the process introduces perturbations that are both targeted and meaningful, enabling robust testing or fine-tuning of the primary system's handling of context modifications. This approach ensures that modifications remain focused on tokens most challenging for the perturbation model, fostering precise and impactful perturbations. As shown in FIG. 1B, system 120 may generate perturbed context 126 (e.g., showing a perturbation based on what word is perturbed) and perturbed context 128 (e.g., showing an ordering of words that is perturbed).

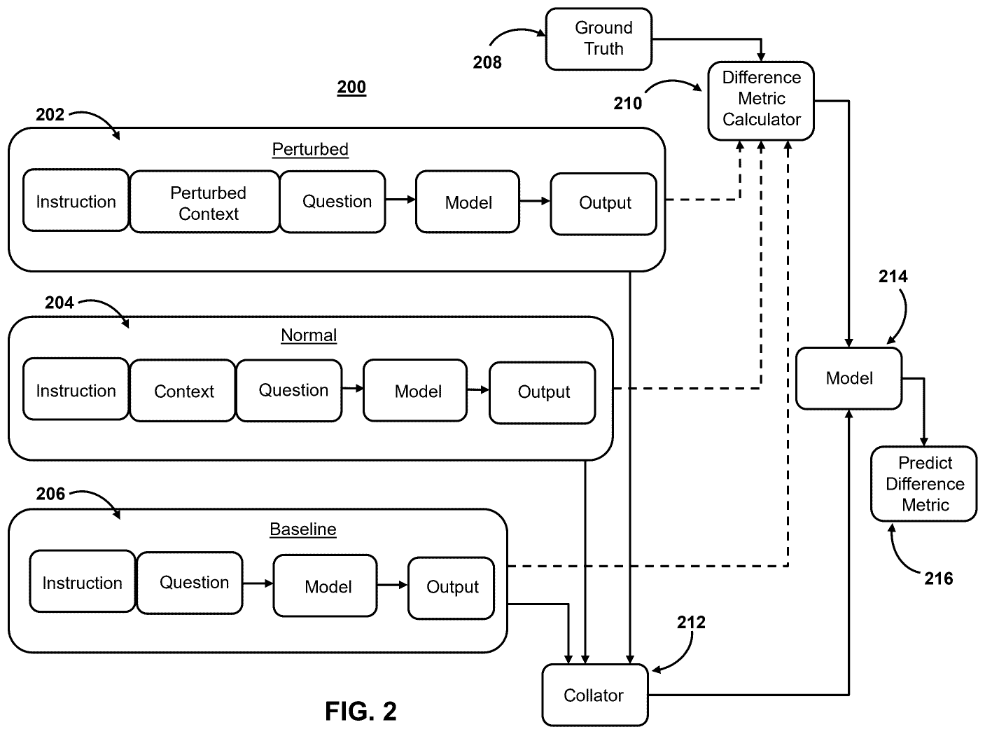

FIG. 2 shows an illustrative diagram for a perturbation model, in accordance with one or more embodiments. For example, system 200 includes perturbed model component 202, normal model component 204, and baseline model component 206. Each of these model components may represent a different condition and may generate an answer that is output to collator 212 and/or difference metric calculator 210.

For example, in a baseline condition (e.g., reflected by baseline model component 206), the model is given only the instruction and question, without any external context. This setup serves to evaluate the model's performance by relying solely on its pre-trained knowledge. The goal is to quantify how the model's uncertainty or confusion manifests when it generates answers without the guidance of relevant context.

In a normal condition (e.g., reflected by normal model component 204), the input prompt includes the instruction, relevant context, and the question. This configuration reflects a standard RAG setting, where the model is expected to leverage both the provided context and the question to produce an accurate response. The aim is to measure how the model's confusion varies in a typical RAG scenario where context plays a crucial role.

In a perturbed condition (e.g., reflected by perturbed model component 202), the model receives the instruction, the question, and a perturbed version of the context (details of the perturbation process are outlined in the next section). The instruction and question remain consistent across all conditions, ensuring that any observed variations in the model's performance can be attributed to the altered context. This setting enables us to measure how the model's confusion fluctuates when faced with noisy or misleading information in the context.

In each of these conditions, system 200 controls the introduction of context perturbations, maintaining uniformity in both the instruction and question. By comparing the NLL across these scenarios, system 200 determines to identify key variations in the model's behavior and its ability to generate accurate responses under different contextual influences.

For example, system 200 utilizes perturbed model component 202, normal model component 204, and baseline model component 206 to analyze and compare outputs generated under different conditions, providing insights into model performance and robustness. Each model component represents a distinct configuration or operational context, allowing the system to evaluate variations in behavior and output quality. Perturbed model component 202 operates under conditions where the input context has been modified or perturbed. This component is designed to assess how well the system adapts to variations, such as token replacements or context alterations, and generates an answer that reflects its ability to process the perturbed input. Normal model component 204 functions with the original, unaltered input context. It represents the standard operating condition of the system and generates an answer based on the expected input, serving as a reference for normal behavior. Baseline model component 206 is configured to operate without certain contextual inputs or under simplified conditions, providing a baseline for comparison. It might, for example, generate an answer without relying on the input context, highlighting the model's reliance on context for accurate output. The answers generated by these model components are then output to collator 212 and/or difference metric calculator 210. The collator aggregates the outputs from all three components, comparing their responses to identify consistencies, discrepancies, or patterns of confusion. For example, it can reveal how the perturbed model's answer diverges from the normal or baseline models.

Difference metric calculator 210 may quantify the deviations between the outputs of the components and a ground truth answer (e.g., retrieved from ground truth component 208), if available. It calculates metrics such as semantic similarity, accuracy, or error rates, providing a numerical assessment of how each model component performs under its respective condition. By integrating these comparisons and metrics, system 200 gains a comprehensive understanding of the impact of perturbations, the robustness of the normal model, and the foundational performance of the baseline model. This enables targeted optimization, fine-tuning, and validation of the system's overall effectiveness in handling diverse input scenarios.

For example, system 200 may process an output from difference metric calculator 210 and/or collator 212 into model 214 (e.g., a regression model) to generate output 216 (which may be a predicted difference metric). System 200 processes outputs from difference metric calculator 210 and/or collator 212 into model 214, which may be a regression model, to generate output 216, a predicted difference metric. The process begins by collecting data from the difference metric calculator, which provides quantitative evaluations of discrepancies between the outputs of the perturbed, normal, and baseline model components and a ground truth or expected answer. These metrics might include semantic similarity scores, accuracy measurements, or error rates. Concurrently, the collator contributes aggregated insights by comparing the outputs of the model components, identifying patterns of consistency, divergence, or confusion.

This combined data serves as input for model 214. As a regression model, model 214 is designed to analyze the relationships and trends within this input data, learning how specific conditions—such as perturbations in context or model differences—affect the outputs of the model components. By using historical data or training on similar scenarios, the regression model establishes predictive relationships between the metrics provided by the calculator and collator and the expected differences in performance. When processing new inputs, model 214 applies these learned relationships to predict the difference metric for a given scenario. This output, output 216, represents the predicted degree of variation or deviation between the model outputs under the specified conditions. It provides actionable insights into how changes in input or model configurations might impact performance, enabling proactive adjustments or optimizations. This approach ensures that system 200 can anticipate and quantify performance differences without exhaustive direct computation, streamlining analysis and enhancing its ability to handle dynamic or novel input scenarios effectively.

For example, after systematically perturbing inputs and generating outputs for the three model components—normal condition (Original), baseline condition (No Context), and perturbed condition (With Perturbed Context)—a system calculates the model's internal confusion by analyzing the model's performance and certainty under each condition. This process begins by collecting outputs for each condition. In the normal condition, the input prompt and context are unaltered, representing the model's standard operating scenario. The system evaluates the model's confidence in generating the output, based on a fully provided context. In the baseline condition, the model processes the input prompt without any additional context, testing its ability to generate meaningful outputs without supplementary information. In the perturbation condition, the input context is modified with systematic alterations, such as token replacements or distortions, to assess the model's robustness and adaptability.

For each condition, the system evaluates key metrics, such as the log-likelihood (LL) of the input prompt, context (if applicable), and the generated output. By comparing these likelihoods across the conditions, the system quantifies the variability in the model's confidence and output quality. For example, differences between the log-likelihood of the output in the normal condition versus the perturbation condition reveal how perturbations affect the model's internal certainty and ability to generate accurate responses. Similarly, discrepancies between the baseline condition and the other two conditions highlight the model's dependency on context to produce coherent and relevant answers. These comparisons enable the system to measure the internal confusion, which is reflected in inconsistencies or drops in performance across the conditions. Metrics, such as likelihood differences, entropy in the likelihood scores, or composite confusion scores, are calculated to provide a comprehensive view of how well the model handles normal, context-free, and perturbed scenarios. This analysis is crucial for identifying weaknesses in the model's processing, and for guiding improvements to enhance robustness, consistency, and context-awareness.

The system may perform a Log-Likelihood (LL) calculation for each condition. For example, for the normal condition, the system calculates: (i) Log-likelihood on the input prompt: LL(IP); (ii) Log-likelihood on the context: LL(C); (iii) Log-likelihood on the generated output based on the input prompt: LL(X IP|IP). For the baseline condition, the system calculates: (i) Log-likelihood on the baseline input prompt; (ii) Log-likelihood on the generated output based on the baseline input prompt. For the perturbation condition, the system calculates: (i) Log-likelihood on the perturbed input prompt: LL(IP′_{C}); (ii) Log-likelihood on the perturbed context: LL(P′_{C}); and (iii) Log-likelihood on the generated output based on the perturbed input prompt: LL(XIP′_{C}|IP′_{C}).

System 200 may then calculate the correctness of the generated text in normal condition. For example, all the log-likelihood numbers calculated above are provided to a regression model as the input. System 200 may use a trained random forest regression model [PVG+11] with, e.g., 100 estimators, as the regression model. During training time, system 200 may use cosine similarity of the embedding of the ground truth and generated an answer under the original condition, as a signal for correctness and as the expected output of the regression model. In this way, the regression model learns to estimate the correctness according to the log-likelihood results on model inputs and outputs generated in different cases. This number is usually a continuous number between 0 and 1, representing the similarity between the model output and the ground truth result. During evaluation, system 200 choses a threshold for that correctness to decide whether the output is good or bad. This threshold value is a hyper-parameter that needs to be adjusted based on the LLM used to generate the answer.

For example, system 200 calculates the correctness of the generated text under the normal condition by leveraging log-likelihood values and a trained regression model to predict how well the generated output aligns with the ground truth. Initially, the system collects the log-likelihood values computed during the normal condition for the input prompt, context, and generated output. These values are provided as input features to a regression model, such as a trained random forest regression model with, for example, 100 estimators, as proposed in [PVG+11]. The regression model is designed to analyze the relationship between the log-likelihood metrics and the correctness of the generated text.

During the training phase, system 200 uses a cosine similarity score between the embeddings of the ground truth and the generated answer under the normal condition as a signal for correctness. This similarity score, a continuous value between 0 and 1, serves as the expected output for the regression model. A score closer to 1 indicates a high degree of similarity, suggesting that the generated answer closely matches the ground truth, whereas a score closer to 0 indicates poor alignment. By training on these similarity scores, the regression model learns to estimate correctness based on the patterns in the log-likelihood results from various components of the model.

During evaluation, the trained regression model processes log-likelihood values to predict a correctness score for the generated text. System 200 then compares this predicted score against a pre-defined threshold, which serves as a hyperparameter to classify the output as good or bad. This threshold is adjustable based on the specific large language model (LLM) being used, allowing the system to fine-tune its evaluation criteria for different model architectures and capabilities. By combining log-likelihood analysis, similarity scoring, and regression-based prediction, system 200 achieves a robust method for evaluating the quality of generated text. This approach provides a nuanced measure of correctness that accounts for both probabilistic metrics and semantic similarity, enabling precise and adaptable quality assessment across various scenarios.

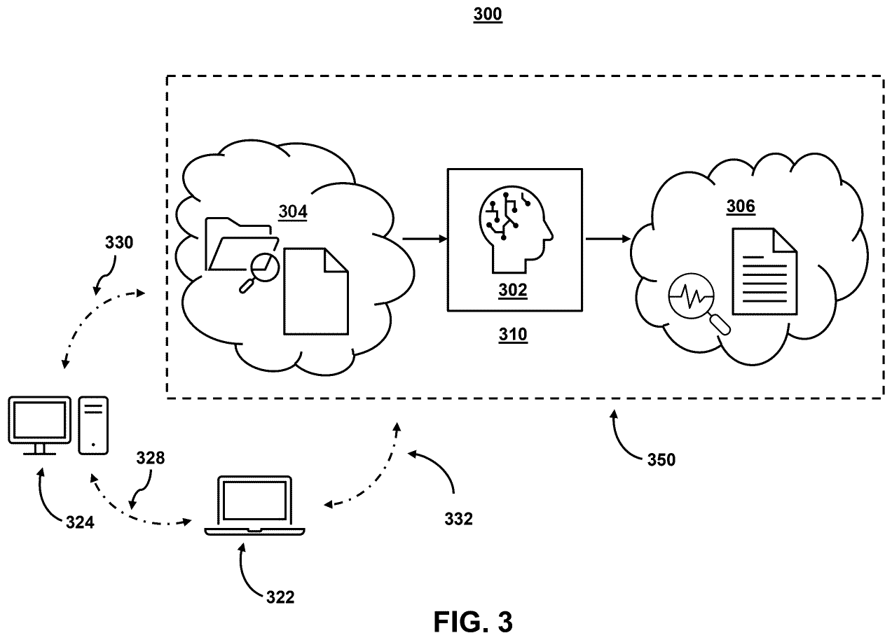

FIG. 3 shows illustrative components for a system for improved data processing of communications across computer networks, in accordance with one or more embodiments. For example, FIG. 3 may show illustrative components for improved data processing of communications across computer networks using trifurcated prompts during communication exchanges. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality, as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may, separately or together, include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review, as the process by which the results are made may be unknown or obscured. This obscurity can create hurdles for identifying errors in the results, as well as improving the models providing the results.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302, as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., an answer, perturbed context, difference metric, predicted difference metric).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function, such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., an answer, perturbed context, difference metric, predicted difference metric).

In some embodiments, the model (e.g., model 302) may automatically perform actions based on outputs 306. In some embodiments, the model (e.g., model 302) may not perform any actions. The output of the model (e.g., model 302) may be used to determine an answer, perturbed context, difference metric, predicted difference metric.

In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer, where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDoS protection, and API layer 350 may use RESTful APIs as standard for external integration.

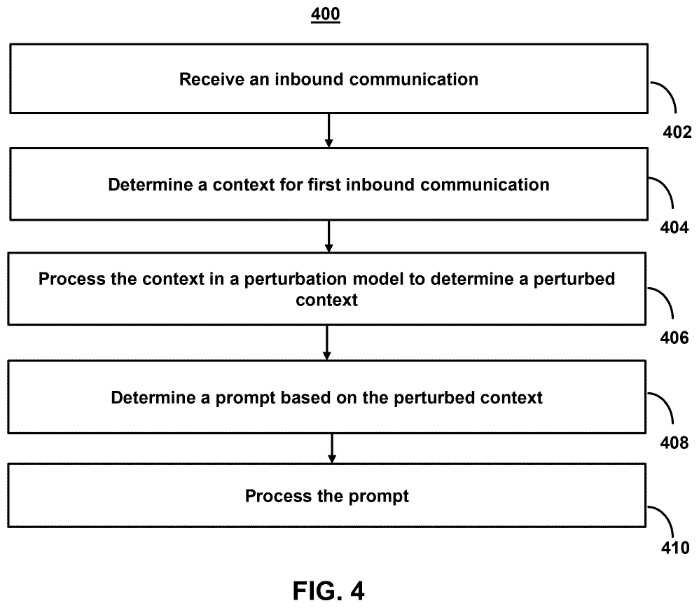

FIG. 4 shows a flowchart of the steps involved in using trifurcated prompts during communication exchanges, in accordance with one or more embodiments. For example, the system may use process 400 (e.g., as implemented on one or more system components described above) in order to improve data processing of communications across computer networks using trifurcated prompts during communication exchanges.

At step 402, process 400 (e.g., using one or more components described above) receives an inbound communication. For example, the system may receive a first inbound communication, wherein the first inbound communication comprises a first text string. The system may receive an inbound communication through designated interfaces or communication channels designed to handle external inputs. When a first inbound communication arrives, it may pass through a receiving mechanism, such as an API endpoint, a message queue, or a monitoring service. This inbound communication may contain a first text string, which serves as the primary payload or data for processing. Upon receipt, the system may perform initial validation to ensure the communication adheres to expected formats and protocols. Once validated, the first text string is extracted and routed to the appropriate processing components or modules within the system. These components may analyze, store, or act upon the text string based on predefined logic or business rules. This structured approach ensures that the inbound communication is properly managed and effectively utilized.

At step 404, process 400 (e.g., using one or more components described above) determines a context for first inbound communication. For example, the system may determine a first context for the first inbound communication based on the first text string. The system may determine the context for a first inbound communication by analyzing the content and attributes of the first text string. This process typically begins with parsing the text string to identify key elements, such as keywords, phrases, or predefined markers that provide clues about its purpose or subject matter. The system may leverage natural language processing (NLP) algorithms to assess semantic meaning, intent, or sentiment within the text. Additionally, metadata associated with the communication, such as timestamps, sender information, or channel of origin, can further contribute to context determination. Using this information, the system applies predefined rules, machine learning models, or context-mapping algorithms to categorize or interpret the communication. This enables the system to establish a first context that informs subsequent processing steps, such as routing the communication to the appropriate module, triggering specific workflows, or generating an automated response.

In some embodiments, the system may determine the first context for the first inbound communication, based on the first text string by determining a plurality of tokens describing to the first text string and determining the first context based on the plurality of tokens. For example, the system may determine the first context for the first inbound communication based on the first text string, by analyzing the text to identify a plurality of tokens that collectively describe its content. This process begins with tokenization, where the system breaks down the text string into smaller linguistic units, such as words, phrases, or symbols. Each token represents a meaningful component of the text, contributing to its overall meaning. The system may then employ natural language processing (NLP) techniques, such as syntactic parsing, part-of-speech tagging, or named entity recognition, to extract relevant tokens that describe the core ideas or themes within the text string. Once the plurality of descriptive tokens is identified, the system aggregates their semantic and syntactic attributes to infer the first context for the inbound communication. This involves analyzing the relationships between tokens, identifying key topics or intents, and mapping the token set to predefined context categories or dynamic contextual models. For example, if the tokens include “appointment,” “schedule,” and “Monday,” the system may determine that the context relates to a scheduling inquiry. By leveraging the descriptive power of multiple tokens rather than relying on isolated elements, the system ensures that the inferred context captures the richness and specificity of the inbound communication. This approach allows for more accurate and nuanced understanding, enabling the system to respond appropriately or route the communication to the correct processing module.

At step 406, process 400 (e.g., using one or more components described above) processes the context in a perturbation model to determine a perturbed context. For example, the system may process the first context in a perturbation model to determine a first perturbed context, wherein the perturbation model determines the first perturbed context by determining a first alternative token for a first token in the first context. The system may process the context in a perturbation model to determine a perturbed context by applying transformation or variation algorithms that introduce controlled changes to the original context. Specifically, the system inputs the first context into the perturbation model, which operates on individual tokens or elements within the context. For instance, the model may identify a first token in the first context and determines a first alternative token based on predefined criteria, such as synonym replacement, semantic similarity, or a stochastic perturbation mechanism. This process may involve consulting a dictionary, thesaurus, or probabilistic model trained to generate alternative tokens while preserving the overall coherence or intent of the context. The model then substitutes the first token with the determined alternative, resulting in a modified or “perturbed” version of the original context. This perturbed context can be used for various purposes, such as robustness testing, generating alternative scenarios, or enhancing the diversity of system responses. The process ensures that the modifications align with the intended scope of the perturbation, while maintaining relevance to the original communication.

In some embodiments, the perturbation model may comprise a first model component trained on a known instruction, a known question, and a known context, wherein the perturbation model comprises a second model component trained on the known instruction, the known question, and a known perturbed context, wherein the perturbation model comprises a third model component trained on the known instruction and the known question, and wherein the third model component is trained without the known context or the known perturbed context. For example, the perturbation model may be constructed by designing and training its components to handle different variations of input data, each with specific configurations of instructions, questions, and contexts. In such cases, the first model component is trained on a dataset that includes a known instruction, a known question, and a known context. This training ensures that the component learns to interpret and respond accurately when all these elements are provided together, effectively establishing a baseline understanding of the relationship between the inputs and the expected outputs. The second model component is trained on a similar dataset but includes a known perturbed context instead of the original context. This perturbed context is generated by applying controlled variations or transformations to the known context, such as substituting tokens, altering structures, or introducing noise. By training on these modified contexts, the second component learns to handle and adapt to altered input scenarios while maintaining output relevance and coherence. The third model component is trained using only the known instruction and the known question, deliberately excluding the known context and the perturbed context. This setup forces the third component to rely solely on the instruction and question, without the additional contextual information. This approach helps the system learn to generate responses in situations where context is unavailable or ambiguous, promoting robustness and generalization in handling incomplete or minimal input data. These three components, when combined, enable the perturbation model to process a variety of input configurations effectively, making it adaptable to diverse scenarios while maintaining consistent performance. The structured training methodology ensures that each component specializes in its designated role while contributing to the overall functionality of the perturbation model.

In some embodiments, the perturbation model may comprise a difference metric calculator component that compares, to a ground truth output, a first component output of a first model component, a second component output of a second model component, and a third component output of a third model component, and wherein the perturbation model comprises a confusion collator component that compares respective answer outputs from the first model component, the second model component, and the third model component. For example, the perturbation model may leverage its components to analyze variations in outputs generated under different training conditions and contexts. The first model component, trained on a known instruction, a known question, and a known context, produces a normal output reflecting the model's performance with complete and unperturbed information. The second model component, trained on the same instruction and question but with a perturbed version of the context, generates a second output that captures how the model adapts to modifications or distortions in the input context. The third model component, trained only on the instruction and question without any context or perturbed context, produces a third output (e.g., a baseline condition) that reveals the model's ability to infer answers in the absence of contextual grounding. The perturbation model's difference metric calculator component compares these outputs against a ground truth output. This comparison quantifies discrepancies between the generated outputs and the expected result, providing insights into how each model component's training conditions impact performance. The calculator evaluates factors like accuracy, semantic similarity, and relevance, assigning a difference metric to each output.

The confusion collator component may take the outputs from the three model components and performs a comparative analysis of their respective answers. By aligning and contrasting these answers, the collator identifies patterns of confusion or divergence in responses, particularly under varying contextual conditions. For example, it may highlight how perturbations in the context affect the second model's consistency relative to the baseline provided by the first model or reveal whether the third model's output aligns more closely with intuition or randomness due to its lack of context. This structured comparison allows the perturbation model to evaluate robustness, sensitivity to context changes, and the influence of context on output quality. These insights can be used to refine training approaches, improve context handling, and optimize the performance of systems that rely on large language models.

In some embodiments, the perturbation model may comprise a regression model that compares outputs from a confusion collator and a difference metric calculator to determine a predicted difference in component outputs based on a plurality of model components. For example, the regression model component may function as a predictive tool that analyzes and quantifies the relationships between outputs from the confusion collator and the difference metric calculator to estimate a predicted difference in component outputs. The confusion collator provides comparative insights into the variability and consistency of outputs generated by different model components under varying contextual conditions. Simultaneously, the difference metric calculator offers quantitative measures of discrepancies between these outputs and a ground truth, capturing performance deviations across the components.

The regression model integrates these inputs—comparative data from the confusion collator and numerical differences from the metric calculator—to identify patterns and correlations. Using historical data or training on similar contexts, the regression model learns how specific perturbations or variations in input contexts influence output differences. It then uses this learned relationship to predict how future or unseen perturbations are likely to affect the outputs of the plurality of model components.

This prediction process enables the perturbation model to estimate the robustness, accuracy, and sensitivity of various components under hypothetical or experimental conditions without requiring exhaustive testing for each scenario. By comparing predicted differences with observed outcomes, the system can refine its training methods, identify components most resilient to perturbations, and enhance overall model performance. The regression model thus acts as an analytical layer, bridging raw comparison data with actionable predictions and insights.

In some embodiments, the system may process the first context in a perturbation model to determine a first perturbed context by receiving a model identifier for the first large language model and selecting the perturbation model from a plurality of perturbation models based on the model identifier. For example, the system may select different perturbation models based on the LLM (of class) of LLM being used. The system may do this by determining respective likelihoods of misidentification by the respective large language model for a plurality of tokens and then determining to replace the first token with the first alternative token, based on a respective likelihood of the respective likelihoods for the first token.

To do so, the system processes a first context in a perturbation model to determine a first perturbed context by leveraging a model-specific approach tailored to the large language model (LLM) in use. The process begins with the system receiving a model identifier that specifies the particular LLM being utilized. Using this identifier, the system selects an appropriate perturbation model from a plurality of available models, each designed to account for the unique characteristics, strengths, and vulnerabilities of a specific class of LLMs. This selection ensures that the perturbation strategy aligns with the operational nuances of the targeted LLM. Once the perturbation model is selected, the system analyzes the first context to evaluate the likelihood of misidentification or misunderstanding by the LLM for each token in the text. It does this by employing the perturbation model to compute respective likelihoods of misidentification for a plurality of tokens. These likelihoods are determined based on factors such as token ambiguity, contextual dependency, or historical performance data of the LLM when handling similar inputs. After calculating the likelihoods, the system identifies a first token within the context that has a high likelihood of misidentification. The perturbation model then determines a first alternative token that serves as a replacement for the identified token. The replacement decision is guided by the respective likelihoods, with the system selecting an alternative token that introduces meaningful variation, while preserving overall coherence or intent. For example, the system might prioritize replacing tokens with higher misidentification probabilities to maximize the perturbation's impact on the LLM's interpretive process. By iteratively applying this process, the system generates a first perturbed context that challenges the LLM in a controlled and systematic manner, facilitating robustness testing, error analysis, or performance optimization. This adaptive approach ensures that the perturbation model dynamically accounts for the specific behaviors and limitations of the LLM being used.

In some embodiments, the system may determine the first alternative token for the first token in the first context, by determining a synonym for the first token and determining the first alternative token based on the synonym. The system may determine the first alternative token for the first token in the first context by employing a structured approach that leverages synonym analysis. The process begins with the system identifying the first token within the context that is to be replaced. It then retrieves potential synonyms for the first token, typically using a synonym database, thesaurus, or semantic network such as WordNet. These synonyms are selected based on their linguistic similarity and contextual compatibility with the original token. Once a set of candidate synonyms is identified, the system evaluates each synonym to determine its suitability as the first alternative token. This evaluation may involve analyzing factors such as the semantic alignment of the synonym with the surrounding text, the likelihood of maintaining the original context's meaning, and the intended purpose of the perturbation (e.g., to challenge a language model's understanding without introducing unrelated content). The system then selects the synonym that best meets these criteria, designating it as the first alternative token. This token is integrated into the context, replacing the original token to create a perturbed version of the input. This approach ensures that the perturbation retains linguistic and semantic coherence while introducing controlled variation to test or refine the target system's performance.

In some embodiments, the system may determine the first alternative token for the first token in the first context by determining a class for the first token and randomly selecting the first alternative token from the class. For example, the system determines the first alternative token for the first token in the first context by classifying the token and leveraging that classification to guide the selection of an appropriate alternative. The process begins with the system analyzing the first token to determine its class, such as its part of speech (e.g., noun, verb, adjective) or semantic category (e.g., color, location, action). This classification can be achieved using linguistic analysis tools, such as natural language processing (NLP) models, or predefined token-class mappings. Once the class of the first token is identified, the system accesses a repository of tokens grouped by similar classes. This repository serves as a pool of potential replacements that align with the original token's grammatical or semantic role in the context. The system then randomly selects the first alternative token from the identified class. Random selection introduces variability in the perturbed context while maintaining the structural and contextual relevance of the replacement. By choosing the first alternative token in this way, the system ensures that the replacement aligns with the grammatical and semantic requirements of the context. This approach allows for controlled perturbation that retains the overall coherence of the input while diversifying the text for testing or adaptation purposes. It is particularly useful in scenarios where introducing variability without losing structural integrity is a priority, such as robustness testing or generating diverse training data.

In some embodiments, the system may process a first text string that comprises a plurality of tokens, wherein determining the first context for the first inbound communication based on the first text string further comprises determining a word phrase based on the plurality of tokens and processing the plurality of tokens, as the word phrase to determine the first context. For example, the system may process a first text string comprising a plurality of tokens by identifying meaningful word phrases and using them to determine the context for the inbound communication. The process begins by analyzing the plurality of tokens in the text string to identify potential word phrases, which are sequences of tokens that collectively convey a distinct meaning or semantic unit. This identification can be achieved using natural language processing (NLP) techniques, such as tokenization, part-of-speech tagging, and syntactic parsing, to detect phrases like noun phrases, verb phrases, or idiomatic expressions. Once a word phrase is identified, the system processes the plurality of tokens as a single, unified phrase rather than as individual tokens. This allows the system to capture the holistic meaning of the phrase, which might be lost if the tokens were analyzed in isolation. The identified word phrase is then used as a key element in determining the first context for the inbound communication. For instance, the system may match the phrase against known patterns, categories, or intent templates to infer the purpose or subject matter of the communication. By processing the tokens as word phrases, the system enhances its ability to accurately interpret the text string, ensuring that nuanced meanings and contextual relationships are preserved. This approach is particularly effective in handling complex or natural language inputs, where individual token-level analysis might lead to ambiguous or incomplete context determination.

For example, processing a word phrase is often better than processing only a single word because word phrases capture a broader and more accurate context of meaning, reducing ambiguity and improving understanding. A single word, when analyzed in isolation, may have multiple meanings or interpretations depending on its role in the sentence or its surrounding context. For instance, the word “bank” could refer to a financial institution or the side of a river. However, when it is part of a word phrase such as “riverbank” or “bank account,” its meaning becomes clear and unambiguous. Word phrases also reflect the syntactic and semantic relationships between tokens, enabling systems to understand the intent or purpose of the communication more effectively. For example, the phrase “high-speed train” conveys a specific concept that is more meaningful than processing “high,” “speed,” and “train” individually, as these words in isolation could lead to unrelated interpretations. Furthermore, processing word phrases improves the accuracy of downstream tasks, such as sentiment analysis, intent recognition, or context mapping. It allows systems to better align with natural human language use, where meaning often emerges from the combination of words rather than isolated tokens. This holistic approach ensures that subtle nuances and complex ideas are not overlooked, leading to more robust and reliable performance in applications like natural language understanding, information retrieval, and conversational AI.

At step 408, process 400 (e.g., using one or more components described above) determines a prompt based on the perturbed context. For example, the system may determine a first prompt for a first large language model, wherein the first prompt comprises a first instruction, a first question, and the first perturbed context. The system may determine a prompt based on the perturbed context by combining the modified context with structured components tailored to guide a large language model (LLM) effectively. The process begins by analyzing the first perturbed context to identify its key themes, objectives, or areas requiring elaboration. Using this analysis, the system constructs a first prompt that includes a first instruction, a first question, and the perturbed context. The first instruction specifies the task or action the LLM should perform, such as summarizing, analyzing, or generating content. The first question is crafted to focus the model's attention on a specific aspect of the perturbed context, ensuring clarity and relevance in the model's response. These elements are then formatted cohesively with the perturbed context as supporting information, creating a comprehensive prompt. This structured approach ensures that the LLM receives clear guidance while leveraging the nuances of the perturbed context, enabling the generation of accurate, context-aware outputs.

At step 410, process 400 (e.g., using one or more components described above) processes the prompt. For example, the system may process the first prompt in the first large language model to generate a first outbound communication. The system may process the prompt by inputting it into a large language model (LLM), which generates a corresponding output based on its understanding and capabilities. When the first prompt is processed, the system may transmit it to the LLM's inference engine, which analyzes the instruction, question, and provided context. The LLM applies its trained parameters to interpret the prompt, leveraging its extensive knowledge base and pre-learned patterns to craft a coherent and contextually appropriate response. This process involves parsing the prompt components, identifying the relationships between the instruction, question, and context, and formulating a structured reply. The generated output, referred to as the first outbound communication, reflects the LLM's ability to synthesize information, answer questions, or perform tasks as specified in the prompt. The system then retrieves the outbound communication, which can be further processed, formatted, or delivered to the intended recipient or system for subsequent use. This seamless interaction ensures efficient and context-sensitive communication.

In some embodiments, the system may determine the first prompt for the first large language model by determining the first instruction based on the first inbound communication and determining the first question based on the first inbound communication. The system determines the first prompt for a LLM by analyzing the first inbound communication to extract relevant information for constructing both the instruction and the question components. The process begins by processing the inbound communication to identify its intent, purpose, or underlying task using NLP techniques, such as intent recognition, sentiment analysis, or topic modeling. Based on this analysis, the system determines the first instruction, which provides a directive to the LLM specifying the desired action. For instance, if the inbound communication involves a request to summarize a document, the system may generate an instruction like “Summarize the key points of the following text.” Simultaneously, the system examines the details and context of the inbound communication to determine the first question, which narrows the scope of the prompt and guides the LLM to focus on specific aspects of the task. For example, if the inbound communication includes a query about product availability, the system may generate a question such as “Which products are currently in stock?” By combining the instruction and the question, the system constructs a structured prompt that effectively conveys the task and contextual requirements to the LLM. This ensures that the LLM processes the prompt accurately and generates a response that aligns with the user's intent or the system's operational goals. The structured approach enables the system to leverage the LLM's capabilities efficiently while maintaining clarity and precision in its interactions.

In some embodiments, the system may process the first prompt in the first large language model to generate the first outbound communication by determining a network task based on the first inbound communication and determining a network component for servicing the network task, based on the first outbound communication. The system processes the first prompt in the first LLM to generate the first outbound communication by aligning the response generation process with the network's operational requirements. Initially, the system analyzes the first inbound communication to determine a network task—a specific function or action that needs to be performed within the system's infrastructure. This task might include actions such as retrieving information, updating a database, triggering a workflow, or interacting with another network component. The determination of the network task is guided by the content and intent of the inbound communication, which is parsed and interpreted using NLP techniques. After generating the first prompt, the system inputs it into the LLM, which produces the first outbound communication. This communication is crafted to address the inbound request, providing a response that either fulfills the task directly or contains the information necessary for downstream components to act upon. The system then evaluates the outbound communication to identify the network task it corresponds to, using predefined mappings or dynamic task identification logic. Finally, the system determines the appropriate network component for servicing the identified network task. This involves selecting a component—such as an API endpoint, a database service, or a backend application—that is best suited to execute the task effectively. The selection process takes into account factors such as the nature of the task, the capabilities of available components, and the requirements of the outbound communication. By seamlessly integrating the LLM's output with the network's task management framework, the system ensures that the generated response translates into actionable outcomes, enabling efficient and context-aware servicing of the inbound communication.

It is contemplated that the steps or descriptions of FIG. 4 may be used with any other embodiment of this disclosure. In addition, the steps and descriptions described in relation to FIG. 4 may be done in alternative orders, or in parallel, to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for improved data processing of communications across computer networks using trifurcated prompts during communication exchanges.
2. The method of any one of the preceding embodiments, further comprising: receiving a first inbound communication, wherein the first inbound communication comprises a first text string; determining a first context for the first inbound communication based on the first text string; processing the first context in a perturbation model to determining a first perturbed context, wherein the perturbation model determines the first perturbed context by determining a first alternative token for a first token in the first context; determining a first prompt for a first large language model, wherein the first prompt comprises a first instruction, a first question, and the first perturbed context; and processing the first prompt in the first large language model to generate a first outbound communication.
3. The method of any one of the preceding embodiments, wherein the perturbation model comprises a first model component trained on a known instruction, a known question, and a known context.
4. The method of any one of the preceding embodiments, wherein the perturbation model comprises a second model component trained on a known instruction, a known question, and a known perturbed context.
5. The method of any one of the preceding embodiments, wherein the perturbation model comprises a third model component trained on a known instruction and a known question, and wherein the third model component is trained without a known context or a known perturbed context.
6. The method of any one of the preceding embodiments, wherein the perturbation model comprises a difference metric calculator component that compares, to a ground truth output, a first component output of a first model component, a second component output of a second model component, and a third component output of a third model component.
7. The method of any one of the preceding embodiments, wherein the perturbation model comprises a confusion collator component that compares respective answer outputs from a first model component, a second model component, and a third model component.
8. The method of any one of the preceding embodiments, wherein the perturbation model comprises a regression model that compares outputs from a confusion collator and a difference metric calculator.
9. The method of any one of the preceding embodiments, wherein processing the first context in a perturbation model to determining a first perturbed context further comprises: receiving a model identifier for the first large language model; and selecting the perturbation model from a plurality of perturbation models based on the model identifier.
10. The method of any one of the preceding embodiments, wherein determining the first alternative token for the first token in the first context further comprises: determining respective likelihoods of misidentification by the first large language model for a plurality of tokens; and determining to replace the first token with the first alternative token based on a respective likelihood of the respective likelihoods for the first token.
11. The method of any one of the preceding embodiments, wherein determining the first alternative token for the first token in the first context further comprises: determining a synonym for the first token; and determining the first alternative token based on the synonym.
12. The method of any one of the preceding embodiments, wherein determining the first alternative token for the first token in the first context further comprises: determining a class for the first token; and randomly selecting the first alternative token from the class.
13. The method of any one of the preceding embodiments, wherein the first text string comprises a plurality of tokens, and wherein determining the first context for the first inbound communication based on the first text string further comprises: determining a word phrase based on the plurality of tokens; and processing the plurality of tokens as the word phrase to determine the first context.
14. The method of any one of the preceding embodiments, wherein determining the first context for the first inbound communication based on the first text string further comprises: determining a plurality of tokens describing to the first text string; and determining the first context based on the plurality of tokens.
15. The method of any one of the preceding embodiments, wherein determining the first prompt for the first large language model further comprises: determining the first instruction based on the first inbound communication; and determining the first question based on the first inbound communication.
16. The method of any one of the preceding embodiments, wherein processing the first prompt in the first large language model to generate the first outbound communication further comprises: determining a network task based on the first inbound communication; and determining a network component for servicing the network task based on the first outbound communication.
17. One or more non-transitory, computer-readable mediums storing instructions that, when executed by a data processing apparatus, cause the data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

What is claimed is:

1. A system for improved data processing of communications across computer networks using trifurcated prompts during communication exchanges, the system comprising:
one or more processors; and
one or more non-transitory, computer-readable mediums comprising instructions that when executed by the one or more processors cause operations comprising:
receiving, by a first server in a computer network, a first inbound communication from a second server in the computer network, wherein the first inbound communication comprises a first text string relating to a first network task, wherein the first text string comprises a plurality of tokens;
determining a first context for the first inbound communication based on the first text string;
processing the first context in a perturbation model to determine a first perturbed context, wherein the perturbation model determines the first perturbed context by determining a first alternative token for a first token in the first context;
determining a first prompt for a first large language model, wherein the first prompt comprises a first instruction, a first question, and the first perturbed context;
processing the first prompt in the first large language model to generate a first outbound communication; and
determining, based on the first outbound communication, a third server for servicing the first network task.

2. A method for improved data processing of communications across computer networks using trifurcated prompts during communication exchanges, the method comprising:
receiving a first inbound communication, wherein the first inbound communication comprises a first text string;
determining a first context for the first inbound communication based on the first text string;
processing the first context in a perturbation model to determine a first perturbed context, wherein the perturbation model determines the first perturbed context by determining a first alternative token for a first token in the first context;
determining a first prompt for a first large language model, wherein the first prompt comprises a first instruction, a first question, and the first perturbed context; and
processing the first prompt in the first large language model to generate a first outbound communication.

3. The method of claim 2, wherein the perturbation model comprises a first model component trained on a known instruction, a known question, and a known context.

4. The method of claim 2, wherein the perturbation model comprises a second model component trained on a known instruction, a known question, and a known perturbed context.

5. The method of claim 2, wherein the perturbation model comprises a third model component trained on a known instruction and a known question, and wherein the third model component is trained without a known context or a known perturbed context.

6. The method of claim 2, wherein the perturbation model comprises a difference metric calculator component that compares, to a ground truth output, a first component output of a first model component, a second component output of a second model component, and a third component output of a third model component.

7. The method of claim 2, wherein the perturbation model comprises a confusion collator component that compares respective answer outputs from a first model component, a second model component, and a third model component.

8. The method of claim 2, wherein the perturbation model comprises a regression model that compares outputs from a confusion collator and a difference metric calculator.

9. The method of claim 2, wherein processing the first context in a perturbation model to determine a first perturbed context further comprises:
receiving a model identifier for the first large language model; and
selecting the perturbation model from a plurality of perturbation models based on the model identifier.

10. The method of claim 2, wherein determining the first alternative token for the first token in the first context further comprises:
determining respective likelihoods of misidentification by the first large language model for a plurality of tokens; and
determining to replace the first token with the first alternative token based on a respective likelihood of the respective likelihoods for the first token.

11. The method of claim 2, wherein determining the first alternative token for the first token in the first context further comprises:
determining a synonym for the first token; and
determining the first alternative token based on the synonym.

12. The method of claim 2, wherein determining the first alternative token for the first token in the first context further comprises:
determining a class for the first token; and
randomly selecting the first alternative token from the class.

13. The method of claim 2, wherein the first text string comprises a plurality of tokens, and wherein determining the first context for the first inbound communication based on the first text string further comprises:
determining a word phrase based on the plurality of tokens; and
processing the plurality of tokens as the word phrase to determine the first context.

14. The method of claim 2, wherein determining the first context for the first inbound communication based on the first text string further comprises:
determining a plurality of tokens describing to the first text string; and
determining the first context based on the plurality of tokens.

15. The method of claim 2, wherein determining the first prompt for the first large language model further comprises:
determining the first instruction based on the first inbound communication; and
determining the first question based on the first inbound communication.

16. The method of claim 2, wherein processing the first prompt in the first large language model to generate the first outbound communication further comprises:
determining a network task based on the first inbound communication; and
determining a network component for servicing the network task based on the first outbound communication.

17. One or more non-transitory, computer-readable mediums, comprising instructions that, when executed by one or more processors, cause operations comprising:
receiving a first inbound communication, wherein the first inbound communication comprises a first text string;
determining a first context for the first inbound communication based on the first text string;
processing the first context in a perturbation model to determine a first perturbed context, wherein the perturbation model determines the first perturbed context by determining a first alternative token for a first token in the first context;
determining a first prompt for a first large language model based on the first perturbed context; and
processing the first prompt in the first large language model to generate a first outbound communication.

18. The one or more non-transitory, computer-readable mediums of claim 17, wherein the perturbation model comprises a first model component trained on a known instruction, a known question, and a known context, wherein the perturbation model comprises a second model component trained on the known instruction, the known question, and a known perturbed context, wherein the perturbation model comprises a third model component trained on the known instruction and the known question, and wherein the third model component is trained without the known context or the known perturbed context.

19. The one or more non-transitory, computer-readable mediums of claim 17, wherein the perturbation model comprises a difference metric calculator component that compares, to a ground truth output, a first component output of a first model component, a second component output of a second model component, and a third component output of a third model component, and wherein the perturbation model comprises a confusion collator component that compares respective answer outputs from the first model component, the second model component, and the third model component.

20. The one or more non-transitory, computer-readable mediums of claim 17, wherein the perturbation model comprises a regression model that compares outputs from a confusion collator and a difference metric calculator to determine a predicted difference in component outputs based on a plurality of model components.
